(19) United States
(12) Patent Application Publication
(10) Pub. No.: US 2008/0308356 A1
(43) Pub. Date: Dec. 18, 2008

(54) Shopping complex, a method of operating a shopping complex, and a method and system for conveying goods in a shopping complex

(76) Inventors: Trevor Spiro, London (GB); John A. Bovill, London (GB); Jonathan D. Dreyfus, Crawley (GB); Anthony D. Stanford, London (GB)

Correspondence Address: DICKSTEIN SHAPIRO LLP, 1825 EYE STREET NW, Washington, DC, 20006-5403, US

(21) Appl. No.: 11/808,878

(22) Filed: Jun. 13, 2007

(51) Int. Cl. G06Q 30/00

(52) U.S. Cl. 186/57

(57) ABSTRACT

A method of operating a shopping complex comprising a plurality of independent retail outlets, the method comprises operating a conveyor system capable of conveying goods purchased in any one of the retail outlets to a plurality of designated locations in the shopping complex; and in response to a purchase of goods at any one of the plurality of retail outlets and at the request of the customer, conveying purchased goods using the conveyor system to a designated location in dependence upon the customer request.

### FIELD OF THE INVENTION

The present invention relates to shopping complex comprising a plurality of independent retail outlets and a method of operating such a shopping complex to deliver purchased goods to a desired location. The present invention also relates to a method and system for conveying goods in a shopping complex comprising a plurality of independent retail outlets.

### BACKGROUND OF THE INVENTION

Modern retail outlets are often aggregated into common buildings in which independent retailers share facilities. In the UK such aggregations are termed shopping centres, shopping arcades or shopping precincts. In North America the term shopping mall is used.

Retail outlets aggregate together in shopping complexes in order to provide a customer with a shopping experience which enables the customer to be able to access a wide range of retail products from a wide range of different retail outlets without the inconvenience of walking or driving long distances between the retail outlets. The shopping complex often also includes leisure facilities such as restaurants, cinemas, health clubs gyms, etc. The desire of operators of shopping complexes and their retail outlet tenants is to encourage the customer to relax and stay longer to shop, thereby increasing their spending within the shopping complex and therefore increasing the profitability of the shopping complex and its tenants.

In shopping complexes retailers rent retail space from the shopping complex owner and enter into an agreement to pay rent and service charges. There is thus a commercial relationship between the parties. Both parties look to maximise their profits.

### SUMMARY OF THE INVENTION

The present inventors have identified that there is significant financial gain to be made from reducing the amount of shopping carried in shopping complexes by customers. It has been identified that if the customer was freed from having to carry bulky shopping bags they are more likely to stay in the shopping complex longer to either purchase more goods or to enjoy the leisure facilities and therefore increase the amount of money spent in the shopping complex. Thus one aspect of the present invention provides a conveyor system in a shopping complex for conveying goods purchased from any of the retail outlets to a location in the shopping complex dependent upon a delivery location selected by the customer. In this way goods purchased from multiple retail outlets can be aggregated and delivered together.

The present inventors have also identified that the retailers and the shopping complex owners benefit when a shopping complex is busy with customers purchasing in a more pleasant environment. An environment of this type costs and the overheads in maintaining that environment need to be shared. Thus in accordance with one aspect of the present invention, a shopping complex is managed by requiring all retail outlets to enter into an agreement with the owners or operators of the shopping complex agreeing to the provision of services including a common goods conveyor system for conveying goods to and from the retail outlets, to and from at least one central storage location and to at least one customer collection location, and to make payments dependent upon recorded purchases.

The term shopping complex used in the present invention refers to a building or set of buildings that contain independent stores (retail outlets) with interconnecting walkways enabling customers to easily walk from store to store. Such walkways may be enclosed or the stores could be located in a single building or linked building structure. In such complexes stores usually share facilities and have a lease arrangement that includes a service element related to such shared facilities. In the UK such shopping complexes are termed shopping centres, shopping arcades or shopping precincts, while in North America the term shopping mall is used.

In accordance with one aspect, the present invention provides a conveying system in a shopping complex comprising a plurality of independent retail outlets, the conveying system comprising a conveyor mechanism for conveying purchased goods to at least one customer collection point; a loading arrangement enabling the loading of purchased goods onto the conveyor mechanism; an unloading arrangement at each collection point enabling the unloading of purchased goods from the conveyor mechanism; a retailer data input system at each retail outlet for inputting conveying information related to purchased goods to enable a customer to specify a collection point as a conveying destination, the conveying information comprising an identification of purchased goods and the conveying destination for the purchased goods; and a conveying control system connected to the retailer data input systems for controlling the conveyor mechanism in response to the conveying information.

In one embodiment the loading arrangement comprises a loading mechanism at each retail outlet to enable purchased goods to be loaded onto said conveyor mechanism at each retail outlet.

In one embodiment the shopping complex includes a central storage location storing goods for at least some of the retail outlets, and the loading arrangement comprises a loading mechanism at the central storage location to enable purchased goods to be loaded onto the conveyor mechanism at the central storage location.

In one embodiment the shopping complex includes a central storage location storing goods for at least some of the retail outlets, and the loading arrangement comprises a loading mechanism at the central storage location to enable purchased goods to be loaded onto the conveyor mechanism at the central storage location and a loading mechanism at each retail outlet to enable purchased goods to be loaded onto the conveyor mechanism at each retail outlet.

In one embodiment the shopping complex includes a goods delivery location for receiving and/or storing goods to be delivered to the retail outlets, the loading arrangement is adapted to enable the loading of goods to be delivered to the retail outlets, and the conveying system includes an outlet unloading arrangement at each retail outlet, and a delivery data input system at the goods delivery location for inputting delivery conveying information related to goods to be delivered, the delivery conveying information comprising an identification of the goods to be delivered and a retail outlet; wherein the conveying control system is adapted to control the conveyor mechanism to convey the goods to be delivered from the delivery location to the retail outlets in accordance with the delivery conveying information.

In one embodiment the conveying control system is adapted to record the delivery of goods and the purchase and conveyance of goods for stock control.

In one embodiment a customer can specify home delivery in place of a collection point as a conveying destination, the shopping complex includes a home delivery transit location, the conveying system includes an unloading arrangement at the home delivery transit location for unloading purchased goods intended for home delivery from the conveyor mechanism, and the conveying information identifies the conveying destination as the home delivery location.

In one embodiment the conveyor mechanism is arranged to be at least in part visible to customers in public areas of the shopping complex to enable customers to view conveyed purchased goods. In one embodiment the conveyor mechanism is arranged adjacent to at least one customer viewing window. In one embodiment the conveyor mechanism is arranged with video monitors to generate a video display of the conveyance of the purchased goods for display in the public areas. In one embodiment the conveyor mechanism is arranged to pass through the public areas of the shopping complex. In one embodiment the conveyor mechanism includes a transparent covering. In one embodiment the conveyor mechanism includes carriers for carrying purchased goods. The carriers can be transparent so that the goods inside can be viewed.

In one embodiment the carriers include an identification mechanism for the unique identification of each carrier, and the retail data input system is adapted to input the conveying information including carrier identification data identifying the identification mechanism for a carrier carrying purchased goods.

In one embodiment the carriers are sealable. This provides for secure conveying of goods.

In one embodiment the carriers are removable from the conveying mechanism and a trolley can be provided for carrying at least one carrier when removed from the conveyor mechanism.

In one embodiment each customer has a unique identifier, the retail data input system is adapted to input the conveying information including a customer identifier, and the conveying control system is adapted to associate a carrier to a customer using the conveying information if no carrier is already associated with the customer and to control the conveyor mechanism to convey a carrier already associated with the customer to a the retail outlet when the conveying information is input at a retail data input system at the retail outlet which identifies the customer.

In one embodiment the conveying control system includes a tracking system for tracking the location of the carriers.

In one embodiment the retail data input system is adapted for inputting the conveying information including a delivery time.

In one embodiment the customer unique identifier is derived from an object carried by the customer or a biometric of the customer.

In one embodiment the conveying system includes at least one customer terminal connected to the conveying control system and adapted to allow a customer to enter their unique identifier and access the conveying information for goods purchased by the customer.

In one embodiment the retail data input system is adapted for inputting the conveying information including a delivery time, each terminal is adapted to allow a customer to change at least one of the conveying destinations and the delivery time for the purchased goods.

In one embodiment a purchase record system is provided for recording a history of purchases made by the customers.

In one embodiment the conveying control system includes a goods tracking system for tracking the location of conveyed goods.

One aspect of the present invention provides a shopping complex comprising a plurality of independent retail outlets; a conveying system as described above; and a central storage location storing goods for each retail outlet; wherein the loading arrangement is adapted to enable purchased goods to be loaded onto the conveying mechanism at the central location for conveying to the retail outlets or to a collection point.

Another aspect of the present invention provides a method of conveying goods in a shopping complex comprising a plurality of independent retail outlets, the method comprising at a retail outlet inputting conveying information related to purchased goods to a retail data input system to enable a customer to specify a conveying destination, the conveying information comprising an identification of purchased goods and the conveying destination for the purchased goods; loading the purchased goods onto a conveyor mechanism; and using a conveying control system connected to the retailer data input systems to control the conveyor mechanism in response to the conveying information to convey purchased goods to the conveying destination.

In one embodiment the loading comprises loading the purchased goods onto the conveyor mechanism at the retail outlet.

In one embodiment the shopping complex includes a central storage location storing goods for each retail outlet, and the loading comprises loading the purchased goods onto the conveyor mechanism at the central storage location.

In one embodiment the shopping complex includes a central storage location storing goods for each retail outlet, and the loading comprises loading the purchased goods onto the conveyor mechanism at the central storage location or loading the purchased goods onto the conveyor mechanism at the retail outlet.

In one embodiment the shopping complex includes a goods delivery location for receiving and/or storing goods to be delivered to the retail outlets, the method including loading goods to be delivered to the retail outlets onto the conveyor mechanism at the delivery location, inputting delivery conveying information related to goods to be delivered, the delivery conveying information comprising an identification of the goods to be delivered and a retail outlet; and controlling the conveying control system to control the conveyor mechanism to convey the goods to be delivered from the delivery location to the retail outlets in accordance with the delivery conveying information.

In one embodiment the conveying control system records the delivery of goods and the purchase and conveyance of goods for stock control.

In one embodiment a customer can specify home delivery or a collection point as a conveying destination, the shopping complex includes a home delivery transit location, and the conveying information identifies the conveying destination as the home delivery transit location or a collection point.

In one embodiment the purchased goods are conveyed by the conveying mechanism to be at least in part visible to customers in public areas of the shopping complex to enable customers to view conveyed purchased goods.

In one embodiment the purchase goods are conveyed by the conveying mechanism adjacent to at least one customer viewing window. In one embodiment video monitors generate a video display of the conveyance of the purchased goods for display in the public areas. In one embodiment the purchase goods are conveyed by the conveying mechanism so as to pass through the public areas of the shopping complex. In one embodiment the purchase goods are conveyed by the conveying mechanism in a transparent covering. The purchase goods can be conveyed by the conveying mechanism in transparent carriers.

In one embodiment the carriers include an identification mechanism for the unique identification of each carrier, and the conveying information includes carrier identification data identifying the identification mechanism for a carrier carrying purchased goods.

In one embodiment the carriers are sealed after the purchased goods are loaded into the carriers.

In one embodiment the carriers are removed from the conveying mechanism at the conveying destination.

In one embodiment at least one carrier is carried on a trolley when removed from the conveying mechanism.

In one embodiment each customer has a unique identifier, the conveying information includes a customer identifier, and the conveying control associates a carrier to a customer using the conveying information if no carrier is already associated with the customer and controls the conveyor mechanism to convey a carrier already associated with the customer to a retail outlet when the conveying information is input at a retail data input system at the retail outlet which identifies the customer.

In one embodiment the location of the carriers is tracked.

In one embodiment the conveying mechanism includes carriers carrying purchased goods.

In one embodiment the carriers include an identification mechanism for the unique identification of each carrier, and the conveying information includes carrier identification data identifying the identification mechanism for a carrier carrying purchased goods.

In one embodiment the carriers are removed from the conveying mechanism at the conveying destination.

In one embodiment each customer has a unique identifier, the conveying information includes a customer identifier, and the conveying control system associates a carrier to a customer using the conveying information if no carrier is already associated with the customer and controls the conveyor mechanism to convey a carrier already associated with the customer to a retail outlet when the conveying information is input at a retail data input system at the retail outlet which identifies the customer.

In one embodiment the conveying information includes a delivery time.

In one embodiment the customer unique identifier is derived from an object carried by the customer or a biometric of the customer. In one embodiment the customer unique identifier is derived from an object carried by the customer or a biometric of the customer, at one or more customer terminals connected to the conveying control system a customer can enter their unique identifier and access the conveying information for goods purchased by the customer.

In one embodiment the conveying information includes a delivery time, including receiving a request at a terminal from a customer to change at least one of the conveying destination and the delivery time for the purchased goods.

In one embodiment a history of purchases made by the customers is recorded.

Another aspect of the present invention provides a method of operating a shopping complex comprising a plurality of independent retail outlets, the method comprising operating a conveyor system capable of conveying goods purchased in any one of the retail outlets to a plurality of designated locations in the shopping complex; and in response to a purchase of goods at any one of the plurality of retail outlets and at the request of the customer, conveying purchased goods using the conveyor system to a designated location in dependence upon the customer request.

In one embodiment the conveyor system is capable of conveying goods from any of the retail outlets to any of the designated locations, and the purchased goods are conveyed by the conveyor system from the retail outlet to the designated location.

In one embodiment goods are stored for the retail outlets in a central storage location remote from the retail outlets in the shopping complex, the conveyor system is capable of conveying goods from the storage location to any one of the designated locations, and the purchased goods are conveyed by the conveyor system from the central storage location to the designated location.

In one embodiment goods can be stored for the retail outlets in a central storage location remote from the retail outlets in the shopping complex, the conveyor system is capable of conveying goods from the storage location to any one of the designated locations and of conveying goods from any of the independent retail outlets to any one of the designated locations, and the retail outlet can elect to have the purchased goods conveyed by the conveyor system from the retail outlet to the designated location or from the central storage location to the designated location.

In one embodiment the designated locations comprise at least one of collection points in the shopping complex and a delivery dispatch location in the shopping complex; the request from the customer comprises one of convey the purchased goods to a collection point and deliver the purchase goods to a location remote from the shopping complex; and in response to the request to deliver the purchased goods to the remote location, the purchased goods are conveyed using the conveyor system to the delivery dispatch location so that the purchased goods can be dispatched for delivery to the remote location.

Another aspect of the present invention provides a shopping complex comprising a plurality of retail outlets operated by unrelated entities; and a conveyor system for conveying goods purchased from the retail outlets to a plurality of customer designatable locations in the shopping complex.

In one embodiment the conveyor system is at least in part visible to customers in public areas of the shopping complex to enable customers to view conveyed purchased goods. In one embodiment the conveyor system extends into the public areas. In one embodiment the conveying system is arranged in non public areas and the shopping complex includes at least one of: windows for viewing at least a part of the conveying system, and a video recording and displaying system to display an image of at least a part of the conveying system.

In one embodiment a central store is provided for storing goods for the retail outlets, wherein the retail outlet can elect to have the purchased goods conveyed to the customer designatable locations from the retail outlet or the central store.

In one embodiment a central store is provided for storing goods for the retail outlets, wherein the purchased goods are conveyed to the customer designatable locations from the central store.

In one embodiment the purchased goods are conveyed to the customer designatable locations from the retail outlet.

In one embodiment at least one customer terminal is provided to enable a customer to designate or change the location to which the purchased goods are conveyed.

In one embodiment the at least one customer terminal is adapted to enable a customer to designate or change a time at which the purchased goods are ready for collection at the designated location.

In one embodiment a delivery dispatch location is provided from which the purchased goods are dispatched for delivery to remote locations; wherein the customer designatable locations comprise at least one of: at least one collection point in the shopping complex and the delivery dispatch location in the shopping complex;

Another aspect of the present invention provides a method of operating a shopping complex comprising a plurality of retail outlets selling goods operated by unrelated entities, the method comprising requiring all entities operating the retail outlets to execute a rental agreement with an operator or owner of the shopping complex to the provision of services including a common goods conveyor system for conveying goods to and from the retail outlets, to and from at least one central storage location and to at least one customer collection location, and to make payments dependent upon recorded purchases; operating the conveyor system to convey goods in accordance with the agreement; recording purchases made for goods conveyed by the conveyor system; and receiving the payments from the entities.

Another aspect of the present invention provides a method of operating a shopping complex comprising a plurality of retail outlets operated by independent entities; the method comprising assigning each customer with a unique identifier code based on an object provided to the customer or a biometric of the customer; when a customer purchases goods from a retail outlet, a record is made of the purchased goods, the customer identifier code, and a customer selected delivery location for the purchased goods from a selection of locations comprising a plurality of collection points in the shopping complex and a remote location, a plurality of the records being made with a common the selected location when the customer makes a plurality of purchases from a plurality of the retail outlets; and delivering the goods purchased from a plurality of the retail outlets for the customer to the selected location.

In one embodiment the purchased goods are delivered to the selected location from either the retail outlet or a central common goods store for the retail outlets.

In one embodiment the retail outlet can determine to deliver the purchased goods from the central goods store for all purchases or only for selected purchases.

In one embodiment at least one customer terminal provides customer access to the records; and the at least one customer terminals receives a customer input to change the selected location.

In one embodiment the records include a time of delivery for the purchased goods, and the at least one customer terminal receives a customer input to change the time of delivery.

Another aspect of the present invention provides a method of operating a shopping complex comprising a plurality of retail outlets operated by independent entities, the method comprising, in response to a purchase of goods at any one of the plurality of retail outlets and at the request of the customer, placing the purchased goods in a carrier on a conveyor system, and conveying the purchased goods in the carrier to one of a plurality of designated locations in the shopping complex in dependence upon the customer request. This method removes or at least reduces the need for shopping bags thus reducing wasted packaging. The goods can be aggregated into an appropriate number of bags in the carrier or one unloaded from the carrier. This is a significant environmental advantage.

Another aspect of the present invention provides a method of advertising in a shopping complex, the method comprising affixing advertising material to carriers for holding purchased goods on a conveyor mechanism, and conveying the goods using the conveyor mechanism in public area of the shopping complex.

### BRIEF DESCRIPTION OF THE DRAWINGS

Embodiments of the present invention will now be described with reference to the accompanying drawings in which:

FIG. 1 is a schematic diagram of a shopping complex in accordance with one embodiment of the present invention showing the stock delivery of goods and the arrival of customers;

FIG. 2 is a schematic diagram of a shopping complex in accordance with the embodiment of the present invention showing the purchase of goods and delivery of purchased goods;

FIG. 3 is a schematic diagram of the conveyor system in accordance with one embodiment of the present invention;

FIG. 4 illustrates a capsule used for carrying goods on the conveyor system of the embodiment of FIG. 3;

FIG. 5 illustrates the capsule of FIG. 4 in more detail;

FIG. 6 is a further diagram illustrating a series of capsules as they would be arranged on the conveyor system;

FIG. 7 is yet a further diagram illustrating the capsule of FIG. 4;

FIG. 8 is a diagram illustrating the conveyor rail of the conveyor system in accordance with the embodiment of FIG. 3;

FIG. 9 is a diagram showing the operation of the conveying mechanism of the embodiment of FIG. 3;

FIG. 10 is a diagram illustrating a shopping complex in accordance with one embodiment of the present invention;

FIG. 11 is a diagram illustrating a shopping complex in accordance with another embodiment of the present invention;

FIG. 12 is a diagram illustrating a shopping complex in accordance with further embodiment of the present invention;

FIG. 13 is a diagram of a customer terminal in accordance with one embodiment of the present invention;

FIG. 14 is a schematic diagram of a shopping centre computing system incorporating a conveying control system in accordance with one embodiment of the present invention; and

FIG. 15 is a flow diagram illustrating the process from purchase of goods to delivery of the goods in accordance with one embodiment of the present invention.

### DESCRIPTION OF SPECIFIC EMBODIMENTS OF THE INVENTION

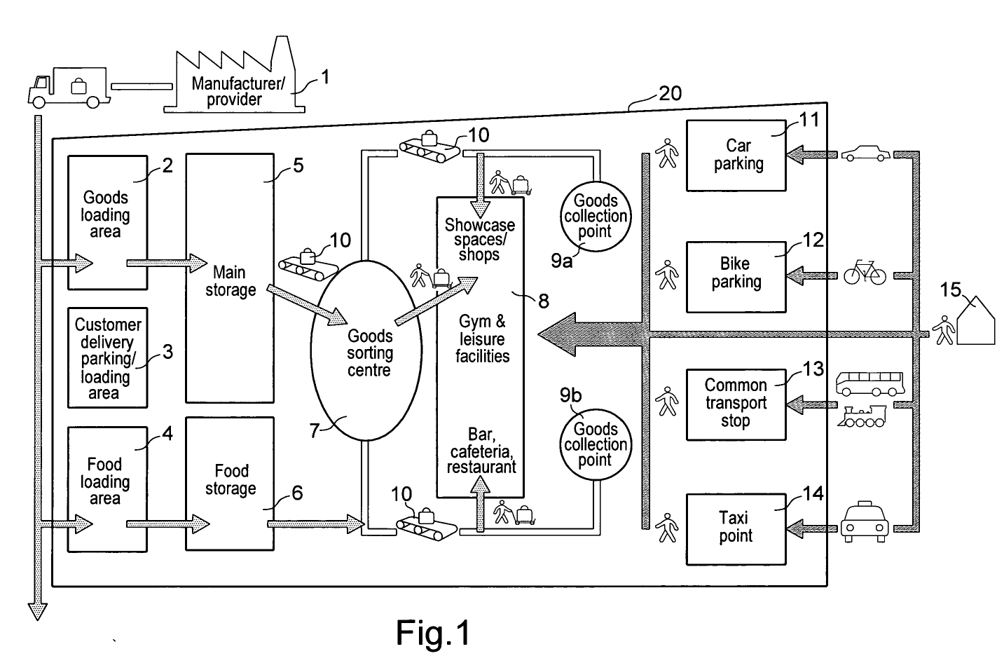

FIG. 1 illustrates the flow of goods and customers into a shopping complex 20 in accordance with one embodiment of the present invention.

Deliveries of goods including food are delivered from manufacturers, providers, suppliers or warehouses 1 to a goods loading area 2 and a food loading area 4 in the loading area of the shopping complex 20. A customer delivery parking and loading area 3 is provided to enable goods purchased from retail outlets in the shopping complex. 20 to be delivered to the customer's home if a retail outlet offers a delivery service. A main or central storage area 5 is provided for the storage of the delivered goods. The main or central storage area 5 can be divided into areas allocated to each retail outlet or separate storage areas can be provided. A food storage area 6 is also provided from which food deliveries can be made via a conveying mechanism 10 to bars, cafeterias, restaurants and the like within the public area 8 of the shopping complex 20.

Goods can be conveyed from the main storage area 5 via the conveying mechanism 10 to a goods sorting centre 7 for the routing of goods via the conveying system 10 to retail outlets in the public area 8 of the shopping complex 20. In an alternative arrangement the main storage area and the goods sorting area can be combined in one area or location. The conveying system 10 is also connected to collection points 9a and 9b for the delivery of purchased goods to the collection points 9a and 9b. The public area 8 of the shopping complex 20 is the area to which the customers have access and includes the retail outlets and may also be provided with gym and leisure facilities. Such an area is often termed ‘front of house’. Areas not usually accessed by the public are often termed ‘back of house’.

Customers can travel from their homes 15 to the shopping complex 20 by car to car parking facilities 11, by bike to bike parking facilities 12, by public transport to common transport stop facilities 13 or by taxi to one or more taxi points 14. Thus customers enter the public area 8 of the shopping complex 20 in order to enter a convivial shopping environment.

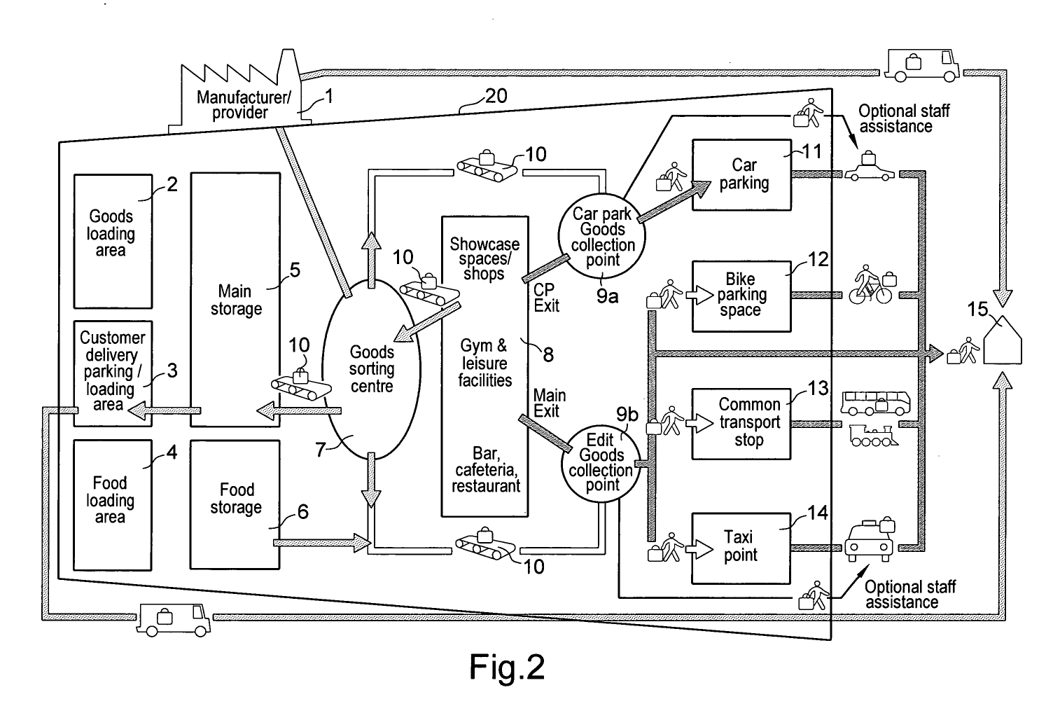

FIG. 2 illustrates the operation of the shopping complex of FIG. 1 during the purchase and delivery phase.

The shopping complex 20 is arranged to allow for the maximum delivery flexibility for the retail outlet and the customer. The retail outlet can operate a retail space having none or a minimum number of stock items (goods) in store. The stock items (goods) are delivered to the customer from the main storage area 5. Thus a customer can either only view the items in a catalogue or on a computer screen in store or they can choose items from the shelves to enable them to physically view and handle the goods, but the goods they purchase will be delivered from the main storage area 5. This greatly simplifies the delivery process and reduces the stock space requirements for the retail outlet. The retail outlet could alternatively opt to keep stock and thus deliver purchased goods either from the retail outlet or in certain circumstances from the main storage area 5.

The conveying of goods from the main storage area 5 to the collection points 9a and 9b and from the retail outlets is via the goods sorting centre 7. In certain circumstances, where goods are bulky or are special order items, the goods sorting centre 7 can facilitate the ordering of goods to be delivered directly from the manufacturer, provider, or warehouse 1. Also, if the customer has elected or a retail outlet requires the goods to be delivered to the customer's home, they are conveyed to the main storage area 5 for delivery to the customer from the customer delivery parking and loading area 3.

Goods that are delivered to collection points 9a and 9b can either be collected in person by the customer, or the customer can elect to have to goods delivered to their car or taxi.

As can be seen from FIGS. I and 2, this embodiment of the present invention provides a common conveying mechanism 10 for conveying goods in the shopping complex 20 to and from the retail outlets in the public area 8 so as to enable purchased goods to be delivered to the collection points 9a and 9b for collection by the customers, and to the delivery location in the main storage area 5 for delivery to the customer's home. The conveying mechanism 10 can comprise any form of conveyer such as those used for luggage conveying in airports. The conveying mechanism 10 is part of a conveying system including a conveying control system (not shown) for controlling the conveying mechanism 10 and for tracking the movement of goods on the conveying system. Any well known tracking system and goods marking can be used including bar coding and radio frequency identification (RFID) tags. Bar code readers or tag readers can be provided a appropriate locations in the shopping complex along the conveyor mechanism path and at loading and unloading points in the retail outlets, the collection points 9a and 9b, the main storage area 5 for customer delivery and for loading goods onto the conveyor mechanism, and the goods sorting centre 7.

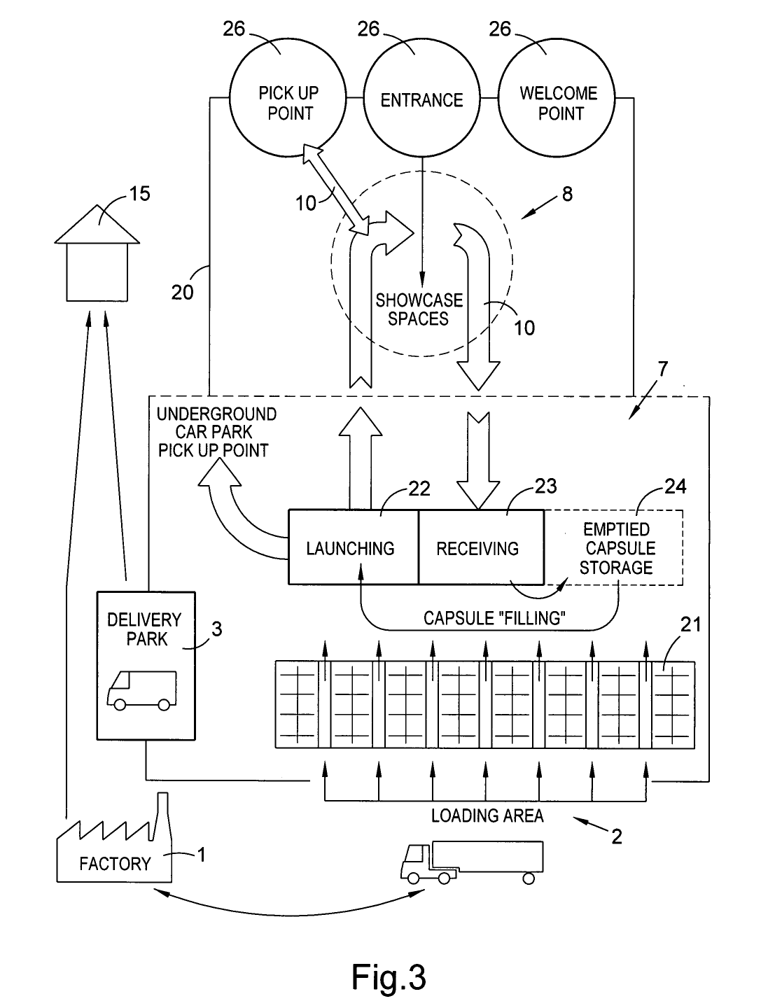

FIG. 3 illustrates the conveying mechanism 10 in more detail. Goods delivered from the factory arrive at the loading area 2. The goods are unloaded into storage racks 21 which can be provided with an automated goods location finder so that the goods can be loaded on and retrieved from the storage racks 21 automatically. The goods sorting area 7 in this example is arranged to use carriers for the goods in the form of capsules (not shown) for carrying the goods on the conveying mechanism 10. Goods are loaded into capsules and loaded onto the conveying mechanism 10 at the launching point 22. The goods are they conveyed to collection points 9 through the public area 8 in showcase spaces. Empty capsules or capsules containing goods conveyed from the retail outlets (not shown) in the public area 8 are received at the receiving area 23 and unloaded from the conveying mechanism 10. If goods are to be delivered, they are stored for pick-up by delivery vehicles in the delivery park 3. Empty capsules are stored in an empty capsule storage area 24.

In the public area 8 at least one entrance 25 is provided having a welcome point 26 comprising a customer terminal to enable a customer to obtain or validate a customer identifier (ID) required for making purchases in the retail outlets. A customer ID can comprise a code held by an object carried by the customer e.g. a magnetic card, a smart card, or an electronic device such as a personal digital assistant (PDA) or a mobile phone. Alternatively or in addition, the identifier can comprise a biometric of the person such as a fingerprint, palm print, retinal scan or facial scan. Such a biometric can be used alone thus alleviating the person from needing to carry an identifier object, or it could be used in addition to an identifier object for added security.

Issuing the customer with a unique ID enables a loyalty scheme to operate to reward customers and to encourage additional spending e.g. by providing the customer with targeted offers. Such loyalty schemes are well know in the art. The information obtained on customer spending behaviour is valuable commercial information.

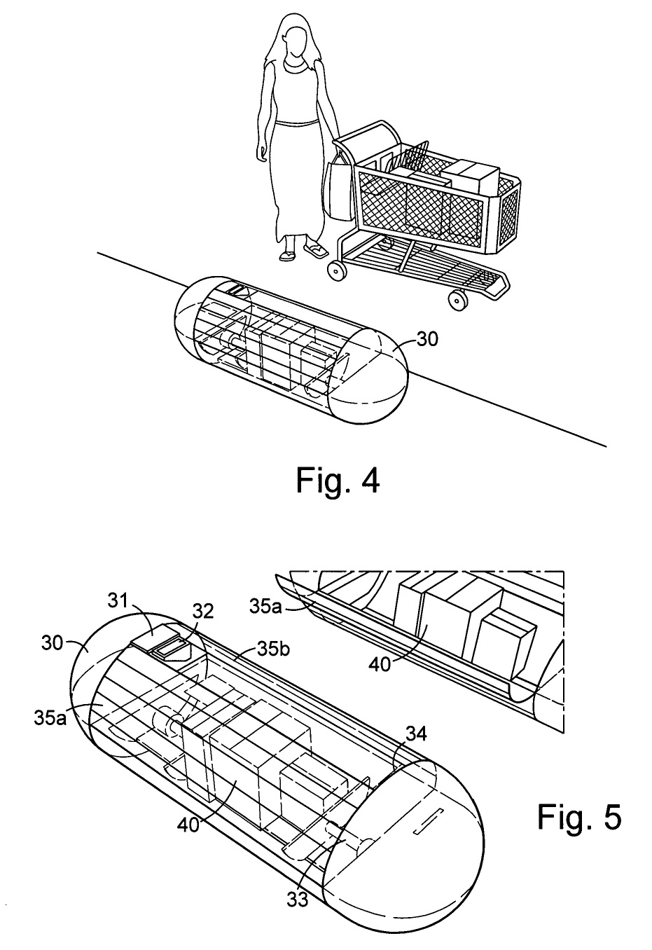

The capsule used in this embodiment will now be described in more detail with reference to FIGS. 4 to 7.

FIG. 4 shows the capsule 30 as an alternative to a traditional shopping basket. In this embodiment of the present invention, the capsule 30 is assigned to a customer to contain their goods purchased from any retail outlet during their visit to the shopping complex 20. To facilitate this each capsule 30 includes an identifier such as a bar code, GPS tag or RFID tag to enable the capsule to be identified, associated with a customer and tracked in the shopping complex 20. The use of a GPS tag on the capsule enables tracking of the capsules when away from the shopping complex legitimately e.g when being used for home deliveries or illegitimately e.g. when stolen. GPS tags can also be used on goods to enable tracking of goods.

FIG. 5 shows the capsule 30 in more detail. A security chip 31 is provided on the capsule 30 to enable the capsule 30 to be uniquely identified and to enable security control of a locking mechanism 34. Thus the capsule 30 can only be unlocked with the correct code using a wireless link to the security chip 31. An LCD screen is provided to show information on the customer and the goods contained in the capsule 30. The goods 40 contained in the capsule 30 are placed on the base of the capsule 30 and a hydraulic holder 33 extends to hold the goods 40 in place. Capsule doors 35a and 35b are closed and locked by the locking mechanism 34 to securely contain the goods 40. The capsules are formed of transparent material to allow the goods 40 inside to be visible from outside.

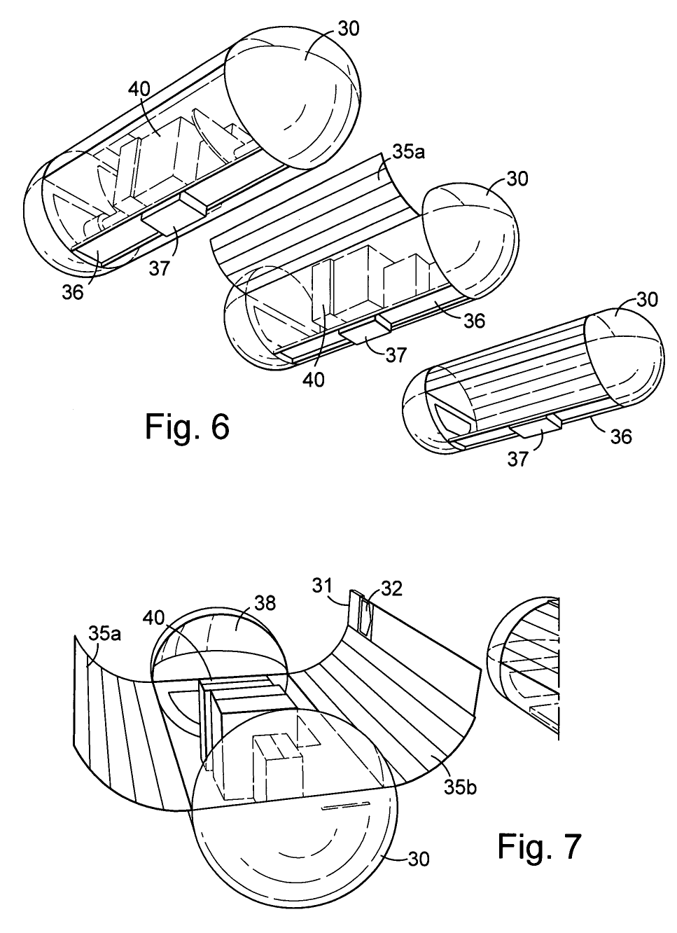

FIG. 6 illustrates a number of the capsules 30 aligned as if carried by a conveyor (not shown). Each capsule 30 has a beam 36 providing structural integrity to the capsule 30. An electromagnetic support 37 is provided on the beam 36 to allow the capsule 30 to be attached and safely carried horizontally and/or vertically by the conveyor.

FIG. 7 illustrates a capsule 30 in an open configuration. At each end of the capsule end compartments 38 are provides and can be used to stored smaller items and can be used to enable the capsule 30 to carry long items. The doors 35a and 35b are flexible and transparent.

The transparency of the capsule 30 allows the goods to be visible and enables the conveyor mechanism to display the conveyed goods as they are conveyed. Thus the conveyor mechanism can convey the capsules in the public area to enable the goods to be displayed. Alternatively, the conveying mechanism could be in the ‘back of house’ areas and viewing windows can be provided to allow customers to view the goods being conveyed. In another embodiment, video cameras can be used to capture images of the conveyed goods for display on video screens in the public area.

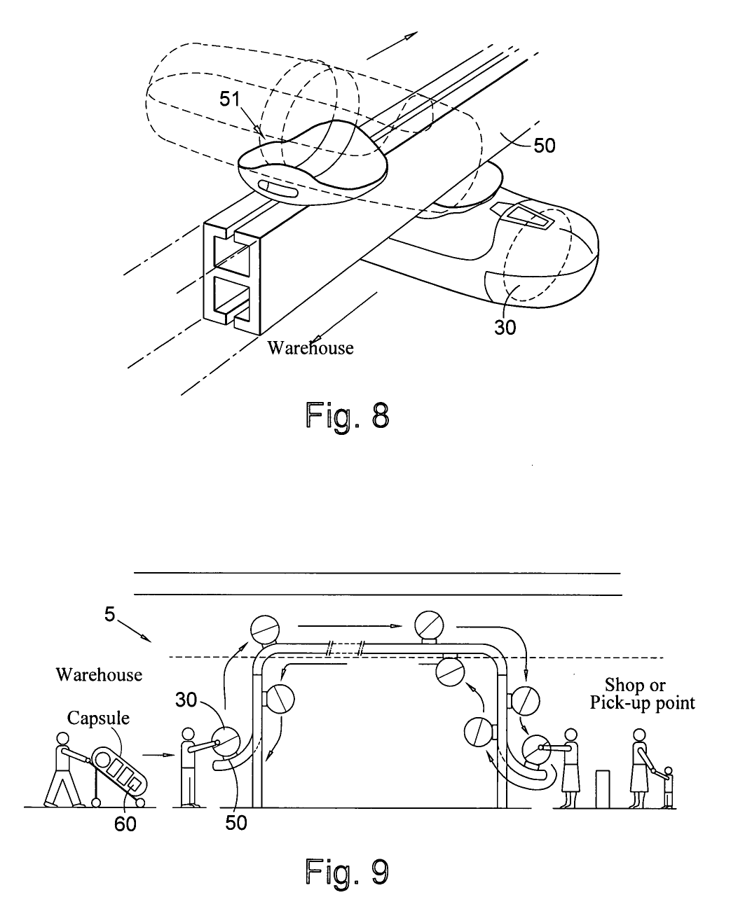

FIG. 8 illustrates a part of the conveyor 50 showing how the capsules 30 are carried by the conveyor 50 in capsule carriers 51. The capsule carriers 51 engage with the electromagnetic supports 37 on the carriers 30 to enable the capsules 30 to be engaged with and disengaged with the conveyor 50. In this embodiment the capsules are shown as being conveyed horizontally. However, the capsules can be conveyed at any angle.

The conveyor 50 is arranged to enable it to follow any contorted path through the shopping complex.

FIG. 9 illustrates the loading or launching and the unloading or receiving of capsules 30. Capsules 30 can be carried on a trolley 60 in the main storage area or warehouse 5 in the shopping complex and loaded onto the conveyor 50. In the retail outlet or pick up point 9a or 9b the capsule 30 can be unloaded from the conveyor 50. As can be seen in FIG. 9, the conveyor enables the two-way conveying of capsules 30.A trolley 60 can also be used in the retail outlet or the pick up point 9a or 9b to enable goods delivered to the retail outlet to be moved easily in the retail outlet without the need to unpack them an repack them onto another carrier and to enable purchased goods to be carrier from the pick up point to a customer's car or taxi without the need to pack them into another carrier i.e. they can be loaded straight from the capsule 30 into the customer's car or taxi and the empty capsule 30 can be returned to the collection point in much the same way as a trolley is used today by customers.

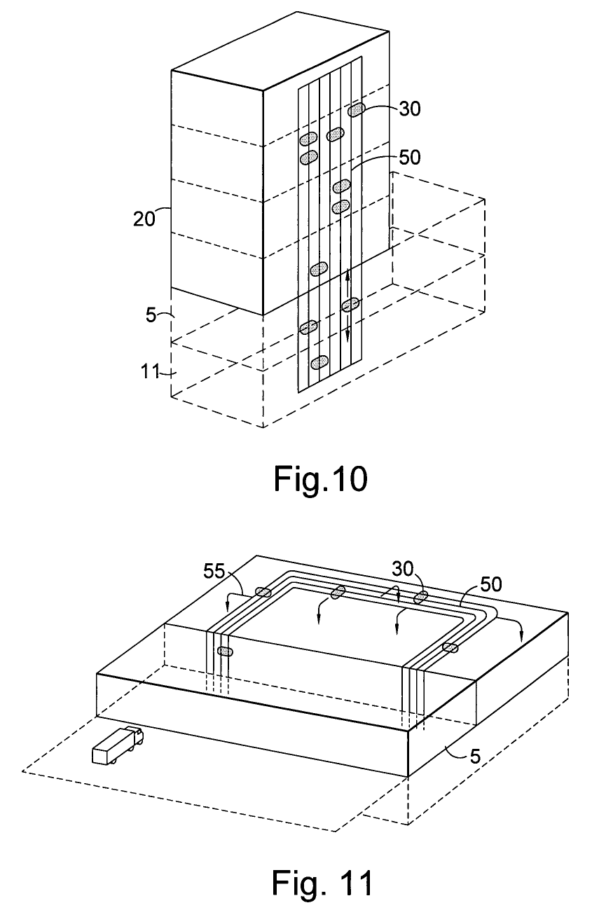

FIG. 10 illustrates a conveying mechanism according to one embodiment of the present invention. In this embodiment the shopping complex 20 is arranged in a vertical structure with retail outlets arranged on different floors of the shopping complex 20. The warehouse or main storage area 5 is arranged, as is common, under the retail outlets. The customer collection points are arranged in the car parking area 11 below the main storage area 5. The conveyor 50 is arranged to convey goods up and down in the manner of a lift to convey the capsules 30 between the retail outlets, the main storage area 5 and the collection points in the car park 11.

FIG. 11 illustrates another embodiment of the present invention in which the shopping complex 20 is arranged with the warehouse or main storage area adjacent to the public area 8 containing the retail outlets. In this embodiment, the conveyor 50 is arranged to extend out of the main storage area 5 and up and over the public area so that the capsules are visible above the customers' heads. Conveyor spurs 55 are provided off the conveyor 50 to convey capsules 30 to and from individual retail outlets.

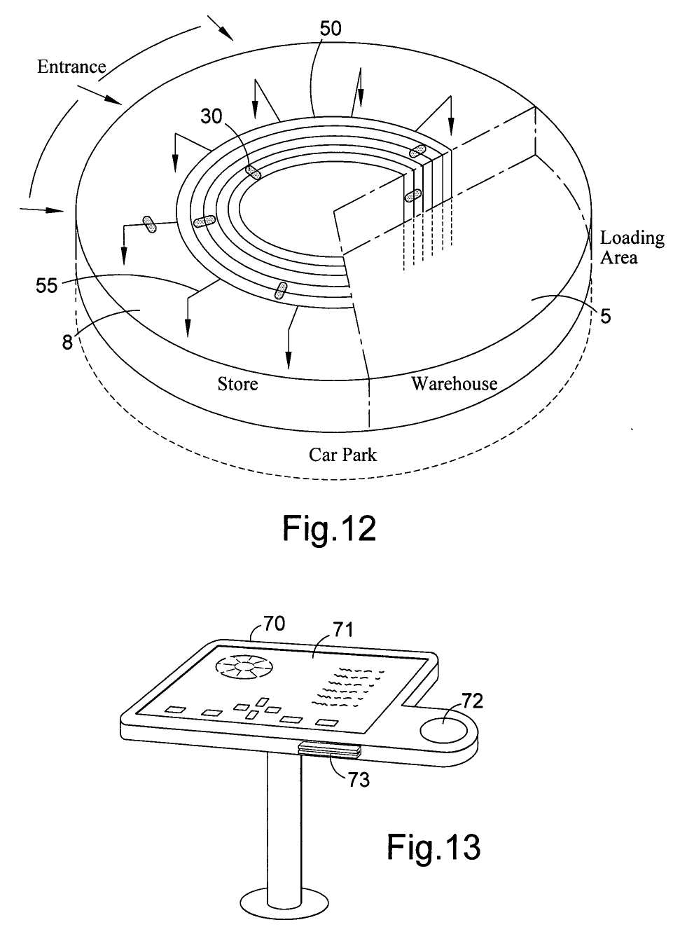

FIG. 12 illustrates another embodiment of the present invention in which the shopping complex 20 is arranged in a circular structure with the warehouse or main storage area 5 adjacent to the public area 8 containing the retail outlets. In this embodiment, the conveyor 50 is arranged to extend out of the main storage area 5 and up and over the public area 8 so that the capsules are visible above the customers' heads and extend in a circular manner around the public area 8. Conveyor spurs 55 are provided off the conveyor 50 to convey capsules 30 to and from individual retail outlets.

Although in FIGS. 4 to 12 the conveying mechanism is described as a conveyor and capsules, the conveying mechanism of the present invention can comprise any suitable conveying system, such as a conveyor belt with open carriers or baskets for carrying the goods. The conveying mechanism can be placed in a transparent tube in place of or in addition to the use of transparent carriers or capsules to enable the conveying mechanism to pass through the public area and enable the goods to be visible to the customers. Alternatively a viewing window could be provided to allow customers to view goods carried by the conveyor mechanism in non-public areas. In another arrangement, video camera can be used to enable images of the conveyed goods to be shown on screens in the public area. The placing of the conveying mechanism in the public areas to enable customers to view conveyed goods enables customers to see purchased goods so that they feel that the shopping complex is busy. Customers will not be carrying their shopping around in bags as in prior art shopping complexes and hence there is a danger that psychologically customers will feel that the shopping complex is not busy and hence it is not a thriving business in which to shop. Thus allowing customers to view purchased goods being conveyed can overcome this. Further, the lack of bags being carrier reduces the advertising opportunities of the retail outlets. The visible conveying of goods overcomes this. Further, the use of carriers or capsules on the conveyor provides further advertising opportunities.

The provision of the conveying mechanism in the public area allows the public to directly see the goods being conveyed. However, there is a danger that the conveying mechanism may fail. Even if this is temporary, it is an embarrassment to the operators of the shopping complex and will not only reflect badly on the operators but will also delay the delivery of the goods to the customers' desired locations. Thus where operators are unwilling to accept this risk, the conveying mechanism can be arranged in the non-public areas with either viewing windows or video cameras. This enables the operators to have better access to the conveyor mechanism for repairs and maintenance and also allows them to either close the viewing windows or change the images shown on the screens so that the failure of the conveying mechanism is not visible to the customers. The conveying mechanism can be provided with a backup system in case of failure. Such a system can comprise another conveyor mechanism or a roadway parallel to the conveyor mechanism in the ‘back of house’ to allow fast vehicle to travel along the roadway to convey goods.

FIG. 13 illustrates a customer terminal 70 for use in the shopping complex 20. Such terminals 70 can be placed at the entrances and public areas of the shopping complex 20. The terminal 70 is provided with a touch sensitive screen 71 to allow customer selections of displayed options. A payment card reader e.g. a debit or credit card reader 73 is provided to enable a customer to use the terminal 70 to access and pay for goods in a manner similar to Internet shopping. A smart card reader 72 is provided in this embodiment to enable customers to identify themselves using their pre-allocated smart cards. As an alternative a magnetic card reader, wireless received, or solid state reader could be used to read a magnetic card, a wireless identifying device such as a PDA or mobile phone or a solid state device. Alternatively or in addition, a biometric reader can be provided to enable the customer to be identified from a biometric reading such as a finger print, hand scan, face scan, or iris scan.

Thus the terminal 70 can be used by customers to identify themselves and to access information on themselves or goods ordered or purchased by themselves. For example, customers can access loyalty scheme information such as special offers available to them and information on loyalty rewards. Customers can also access information on goods being conveyed by the conveying mechanism to enable them to request the conveying destination and time to be changed. The customer can identify themselves, select from the goods being conveyed i.e. select only certain goods or all goods, select one or more conveying destinations i.e. the some goods can be conveyed to one destination and others to a different destination, and can select a time or times of delivery. If a customer wishes goods to be delivered to more than one location and in one embodiment of the invention the goods are contained in a single capsule or carrier assigned to the customer, the capsule or carrier will be dispatched to the main storage area or an intermediate area for separation for the goods into two or more capsules or carriers for conveying to two or more respective destinations.

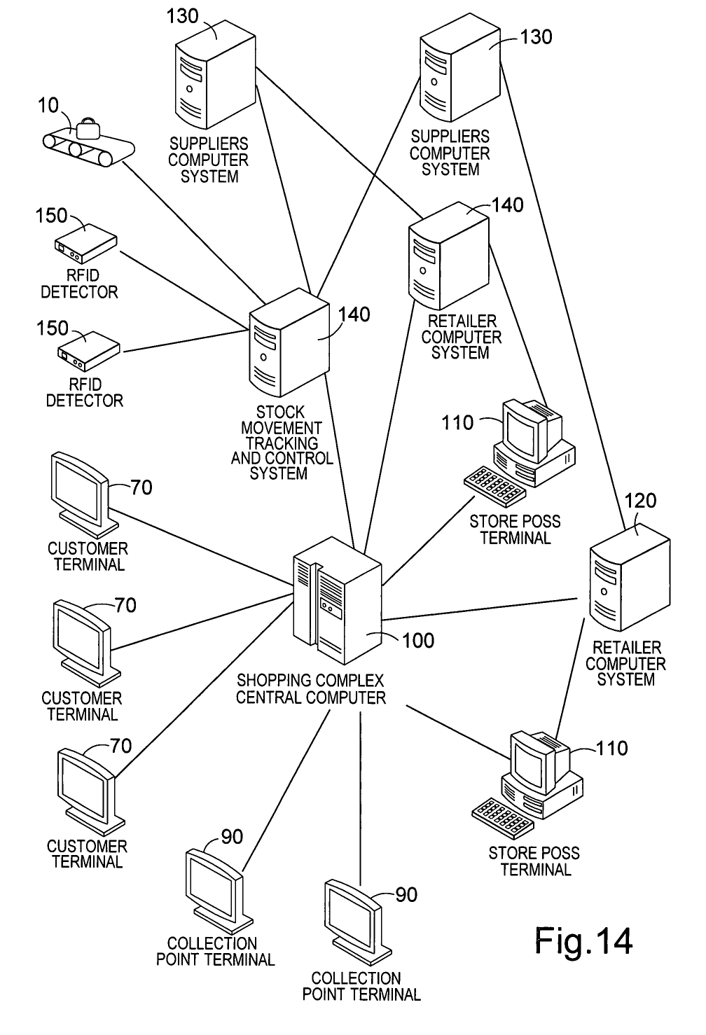

FIG. 14 is a schematic diagram of a computer network according to one embodiment of the present invention for the control and management of the shopping complex.

A central computer system 100 is provided connected to the customer terminals 70 for storing the customer information, purchased goods information and associated capsule and conveying information. Suppliers computer systems 130 are operated by suppliers of goods and are usually remote from the shopping complex and networked to retail computer systems 120 operated by operators or retail outlets in the shopping complex. Retail chains having retail outlets in many locations can operate the retail computer systems 120 and thus the retailer computer systems 120 are not generally located in the shopping complex. A store point of sale (POS) terminal 110 is provided in each retail outlet. These are generally linked to a retailer computer system 120 operated by the operator of the retail outlet. Thus the conventional supply chain management and stock control management between suppliers, retailers and their retail outlets is provided for. In addition the store POS terminals 110 and the retailer computer systems 120 are linked to the central computer 100 to enable the operator of the shopping complex to obtain information on goods transactions made in the retail outlets in the shopping complex for management and billing purposed as will be described in more detail below.

The shopping complex is also provided with a stock movement tracking and control system 140 linked to the central computer 100 for the control and tracking of goods conveyed within the shopping complex by the conveying mechanism 10. The tracking and control system controls the conveying mechanism 10 based on the following shopping complex data:
1. Purchased goods delivery information input from the store POS terminals 110 e.g. the goods to be conveyed, the capsule ID, the customer ID, the store POS identity, the destination ID, and the time of delivery
2. Customer request information input at the customer terminals 70 e.g. the goods to be conveyed, the customer ID, the destination ID, and the time of delivery.
3. Goods or capsule location information from RFID detectors located around the conveying mechanism e.g. detector ID and goods identification information or capsule ID
4. Goods delivery information from suppliers computer systems 130 or store POS terminals 110 e.g. stock goods to be delivered, goods identification information or capsule ID, and store POS identity

The shopping complex data can be gathered and stored in the central computer 100 so that it can be used for stock control purposes. The links to the retailer computer systems 120 enable the exchange of stock control information. This can be used as a basis for payments by the operators of the retail outlets and the shopping complex operator as will be described in more detail below.

Collection point terminals 90 are provided at collection points 9a and 9b and linked to the central computer I 00 to enable customers, or collection point operators to enter details of goods collected at the collection points so as to update status information to indicate that the goods have been collected and are no longer awaiting collection at a collection point.

Although a specific connection of components is shown in FIG. 14, this is merely one embodiment of the present invention and any configuration of networked computers can be used. For example, the tracking and control system 140 and the central computer 100 could be an integrated computer system.

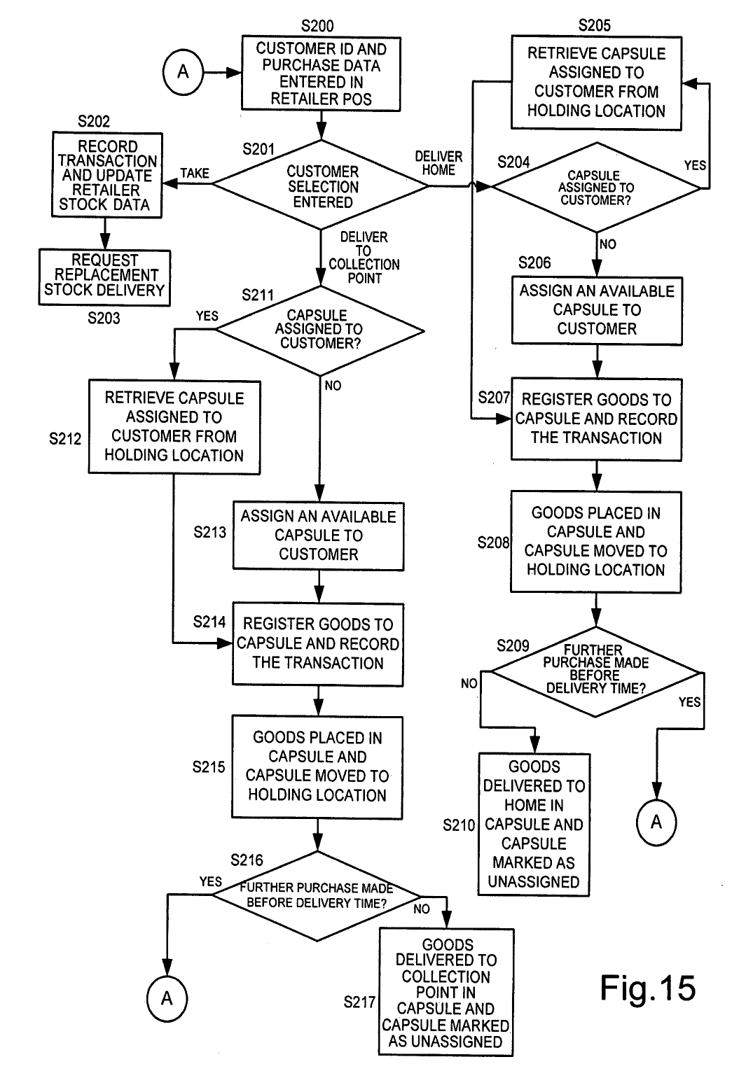

FIG. 15 is a flow diagram illustrating the purchase and delivery process in the shopping complex according to one embodiment of the present invention.

At the time of purchase of goods at a retail outlet the identity of the goods is entered such as by conventional bar code reading of the goods at the store POS terminal 110 (step S200). Also a customer's ID is entered using either the object they are carrying which holds the ID and/or by a biometric scan. A customer can then elect to take the goods if they are available from the shelves in the store, have the goods delivered to home, or have the goods delivered to a collection point 9a or 9b (step S201). If the customer elects to take the goods, a record of the transaction is made in retailer computer system 120 and the stock data is updated (step S202). A request for replacement stock to be delivered to the retail outlet by the conveying mechanism 10 is then made to the stock movement tracking and control system 140 (step S203).

If the customer elects to have the goods delivered to an off-site destination such as their home, or if the retail outlet designates such a delivery option as a requirement e.g. for bulky or heavy goods, if a capsule 30 is not assigned to a customer (step S204) an available capsule 30 is identified using the store POS terminal 110 and the capsule 30 is retrieved (step S206). Empty capsules 30 can be available in the retail outlet, stored in the main storage area 5, or stored at another location for conveyance to the retail outlet when requested. If a capsule 30 is already assigned to the customer, the capsule 30 is identified from association data stored in the central computer 100 and retrieved from the main storage area 5 or a holding location for holding pre-assigned and partially full capsules 30 (step S205). If the assigned capsule 30 is full, this can be noted in the association data and hence when a request is made for the capsule 30, an empty capsule 30 is retrieved instead and the customer is indicated as having multiple capsules 30 assigned to them. The purchased goods are recorded as a transaction in association with the capsule 30 in the central computer 100 (step S207), which includes the customer designated delivery location which indicates that the goods are to be delivered to a home delivery location by the conveying mechanism 10, the home delivery address, and the time of delivery. The purchased goods are loaded into the capsule 30 at the retail outlet (step S208) and conveyed by the conveying mechanism 10 to the holding location. The holding location can be a separate location to enable capsules 30 to be delivered to the retail outlets quickly, or the holding area can be an area of the main storage area 5. If no further purchases are made by the customer before a delivery time (step S209), which can be a predetermined time before the customer designated delivery time to designate a time of dispatch from the shopping complex 20, the goods are delivered to the home address in the capsule 30. When the goods are unloaded at the home address from the capsule 30, the capsule 30 can be marked in the central computer 100 as unassigned and can be returned to the shopping centre 20 for reuse (step S2 10). Alternatively, the capsules 30 can be unloaded into delivery bags or packaging at the shopping centre delivery loading area 3. If a customer makes a further purchase (step S209), the process flow returns to step S200.

If the customer elects to have the goods delivered to a collection point 9a or 9b (step S201), if a capsule 30 is not assigned to a customer (step S211) an available capsule 30 is identified using the store POS terminal 110 and the capsule 30 is retrieved (step S212). Empty capsules 30 can be available in the retail outlet, stored in the main storage area 5, or stored at another location for conveyance to the retail outlet when requested. If a capsule 30 is already assigned to the customer, the capsule 30 is identified from association data stored in the central computer 100 and retrieved from the main storage area 5 or a holding location for holding pre-assigned and partially full capsules 30 (step S213). If the assigned capsule 30 is full, this can be noted in the association data and hence when a request is made for the capsule 30, an empty capsule 30 is retrieved instead and the customer is indicated as having multiple capsules 30 assigned to them. The purchased goods are recorded as a transaction in association with the capsule 30 (step S214), which includes the customer designated delivery location which indicates that the goods are to be delivered to a designated collection point 9a or 9b by the conveying mechanism 10, and the time of delivery to the collection point 9a or 9b. The purchased goods are loaded into the capsule 30 at the retail outlet (step S215) and conveyed by the conveying mechanism 10 to the holding location. The holding location can be a separate location to enable capsules to be delivered to the retail outlets quickly, or the holding area can be an area of the main storage area 5. If no further purchases are made by the customer before a delivery time (step S2 16), which can be a predetermined time before the customer designated delivery time to designate a time of dispatch from the holding area to the collection point 9a or 9b, the goods are delivered to the collection point 9a or 9b in the capsule 30. The capsule 30 can be taken off the conveying mechanism 10 and the goods unloaded at the customer's car or taxi from the capsule 30, and when the capsule 30 is returned to the collection point 9a or 9b, the capsule 30 can be marked in the central computer 100 using the collection point terminal 90 as unassigned (step S217). Alternatively, the capsules 30 can be unloaded into delivery bags or packaging at the collection point 9a or 9b. If a customer makes a further purchased (step S216), the process flow returns to step S200.

This method allows for the aggregation of goods from multiple retail outlets into one or a plurality of capsules 30, which are assigned to each customer. The method can be used with any form of carrier for the goods. Also, the purchased goods can be loaded onto the conveying mechanism 10 either at the retail outlet or at the main storage area 5, depending upon where the retail outlet keeps its stock. If the retail outlet wishes purchased goods to come from stock stored in the main storage area 5, when a customer makes a purchase, the capsule 30 is not retrieved and sent to the retail outlet but is instead retrieved from the main storage area 5 or the holding area and the goods are loaded into the capsule 30 from the main storage area 5.

In a simpler embodiment of the present invention, purchased goods are loaded onto the conveying mechanism in a bag or contained. The single purchase of goods from a retail outlet is kept together but goods are not aggregated from a plurality of retail outlets. The goods can be loaded on the conveying mechanism at the retail outlet or at the main storage area dependent upon where the retail outlet keeps its stock. The goods are delivered to the designated collection point or delivery area 3. The customer can collect the goods from the collection point upon identification. Alternatively, the goods can be assigned a delivery number and the customer is given a receipt with the number on. The customer can simply collect the goods by showing a person at the collection point the receipt.

Loading and unloading mechanisms can be provided at each retail outlet, the main storage location and the collection points. These can simply be mechanisms allowing access to the conveyor, or they can comprise complex loading and unloading mechanisms such as that described above for the capsules.

The carriers or capsules can be adapted to suit the goods being conveyed. If the invention is used for conveying perishable goods, the carriers or capsules can include an environmental control system to control the environment in the carrier or capsule e.g. temperature, humidity, light or even pressure.

The storage of stock control data in the central computer enables the shopping complex operator to charge the operators of the retail outlets based on the stock movement within the shopping complex. Thus the shopping complex operator shares in the financial profit of the retail outlets operator. If the retail outlet does well, the shopping complex operator also does well.

In one embodiment of the present invention, the retail outlet operators are required to enter into a rental agreement for the services they receive in the shopping complex which requires them to use the conveying mechanism provided throughout the shopping complex to have the purchased goods conveyed for the customers either from the retail outlet or from the central storage area. The retail outlet operators are also required to share their sales information via the computer network so that the central computer stores stock and sales information to not only enable stock movement but also to enable charges by the shopping complex operator for the services to be based on sales by the retail outlet. Thus in this way, the integrity of the shopping complex conveying environment is retained and controlled by the operator of the shopping complex. No retail outlet can opt out of having their goods conveyed, thereby diluting the ‘bagless’ shopping experience for customers in the shopping complex.

The conveying mechanism of the present invention can include an express conveying path along which goods can be conveyed at a higher speed for faster delivery e.g. for immediate pick-up. Such a express conveyor can comprise an alternative conveyor mechanism operating at high speed but with a reduced capacity. Such a conveyor mechanism may have a more direct route to certain collection points which may be designated as express collection points.

Where a retail outlet elects to store their goods for delivery in the central storage area, the size of the retail outlet can be reduced and hence the rental overhead for the business is lower.

It can be seen that embodiments of the present invention provide an environmentally friendly shopping process in which the packaging used for purchased goods can be reduced by the use of the conveying mechanism.

Although the present invention has been described with reference to specific embodiments it will be readily apparent to a skilled person in the art that modifications lie within the spirit and scope of the present invention.

What is claimed is:

1. A conveying system in a shopping complex comprising a plurality of independent retail outlets, the conveying system comprising:
a conveyor mechanism for conveying purchased goods to at least one customer collection point;
a loading arrangement enabling the loading of purchased goods onto said conveyor mechanism;
an unloading arrangement at said at least one collection point enabling the unloading of purchased goods from said conveyor mechanism;
a retailer data input system at each retail outlet for inputting conveying information related to purchased goods to enable a customer to specify a said collection point as a conveying destination, said conveying information comprising an identification of purchased goods and said conveying destination for the purchased goods; and
a conveying control system connected to said retailer data input systems for controlling said conveyor mechanism in response to said conveying information.

2. A conveying system according to claim 1, wherein said loading arrangement comprises a loading mechanism at each said retail outlet to enable purchased goods to be loaded onto said conveyor mechanism at each said retail outlet.

3. A conveying system according to claim 1, wherein said shopping complex includes a central storage location storing goods for at least some of said retail outlets, and said loading arrangement comprises a loading mechanism at said central storage location to enable purchased goods to be loaded onto said conveyor mechanism at said central storage location.

4. A conveying system according to claim 1, wherein said shopping complex includes a central storage location storing goods for at least some of said retail outlets, and said loading arrangement comprises a loading mechanism at said central storage location to enable purchased goods to be loaded onto said conveyor mechanism at said central storage location and a loading mechanism at each said retail outlet to enable purchased goods to be loaded onto said conveyor mechanism at each said retail outlet.

5. A conveying system according to claim 3, wherein said shopping complex includes a goods delivery location for receiving and/or storing goods to be delivered to said retail outlets, said loading arrangement is adapted to enable the loading of goods to be delivered to said retail outlets, and said conveying system includes an outlet unloading arrangement at each said retail outlet, and a delivery data input system at said goods delivery location for inputting delivery conveying information related to goods to be delivered, said delivery conveying information comprising an identification of the goods to be delivered and a said retail outlet; wherein said conveying control system is adapted to control said conveyor mechanism to convey said goods to be delivered from said delivery location to said retail outlets in accordance with said delivery conveying information.

6. A conveying system according to claim 4, wherein said shopping complex includes a goods delivery location for receiving and/or storing goods to be delivered to said retail outlets, said loading arrangement is adapted to enable the loading of goods to be delivered to said retail outlets, and said conveying system includes an outlet unloading arrangement at each said retail outlet, and a delivery data input system at said goods delivery location for inputting delivery conveying information related to goods to be delivered, said delivery conveying information comprising an identification of the goods to be delivered and a said retail outlet; wherein said conveying control system is adapted to control said conveyor mechanism to convey said goods to be delivered from said delivery location to said retail outlets in accordance with said delivery conveying information.

7. A conveying system according to claim 1, wherein said conveying control system is adapted to record the delivery of goods and the purchase and conveyance of goods for stock control.

8. A conveying system according to claim 1, wherein a customer can specify home delivery in place of a said collection point as a conveying destination, said shopping complex includes a home delivery transit location, said conveying system includes an unloading arrangement at said home delivery transit location for unloading purchased goods intended for home delivery from said conveyor mechanism, and said conveying information identifies said conveying destination as said home delivery location.

9. A conveying system according to claim 1, wherein said conveyor mechanism is arranged to be at least in part visible to customers in public areas of said shopping complex to enable customers to view conveyed purchased goods.

10. A conveying system according to claim 9, wherein said conveyor mechanism is arranged adjacent to at least one customer viewing window.

11. A conveying system according to claim 9, wherein said conveyor mechanism is arranged with video monitors to generate a video display of the conveyance of the purchased goods for display in said public areas.

12. A conveying system according to claim 9, wherein said conveyor mechanism is arranged to pass through said public areas of said shopping complex.

13. A conveying system according to claim 12, wherein said conveyor mechanism includes a transparent covering.

14. A conveying system according to claim 12, wherein said conveyor mechanism includes transparent carriers for carrying purchased goods.

15. A conveying system according to claim 14, wherein said carriers include an identification mechanism for the unique identification of each said carrier, and said retail data input system is adapted to input said conveying information including carrier identification data identifying said identification mechanism for a said carrier carrying purchased goods.

16. A conveying system according to claim 14, wherein said carriers are sealable.

17. A conveying system according to claim 14, wherein said carriers are removable from said conveying mechanism.

18. A conveying system according to claim 17, including a trolley for carrying at least one said carrier when removed from said conveyor mechanism.

19. A conveying system according to claim 15, wherein each said customer has a unique identifier, said retail data input system is adapted to input said conveying information including a customer identifier, and said conveying control system is adapted to associate a said carrier to a customer using said conveying information if no said carrier is already associated with said customer and to control said conveyor mechanism to convey a said carrier already associated with said customer to a said retail outlet when said conveying information is input at a said retail data input system at said retail outlet which identifies said customer.

20. A conveying system according to claim 15, wherein said conveying control system includes a tracking system for tracking the location of said carriers.

21. A conveying system according to claim 14, wherein said carriers are sealable

22. A conveying system according to claim 1, wherein said conveying mechanism includes carriers for carrying purchased goods.

23. A conveying system according to claim 22, wherein said carriers include an identification mechanism for the unique identification of each said carrier, and said retail data input system is adapted to input said conveying information including carrier identification data identifying said identification mechanism for a said carrier carrying purchased goods.

24. A conveying system according to claim 22, wherein said carriers are removable from said conveying mechanism.

25. A conveying system according to claim 24, including a trolley for carrying at least one said carrier when removed from said conveyor mechanism.

26. A conveying system according to claim 23, wherein each said customer has a unique identifier, said retail data input system is adapted to input said conveying information including a customer identifier, and said conveying control system is adapted to associate a said carrier to a customer using said conveying information if no said carrier is already associated with said customer and to control said conveyor mechanism to convey a said carrier already associated with said customer to a said retail outlet when said conveying information is input at a said retail data input system at said retail outlet which identifies said customer.

27. A conveying system according claim 23, wherein said conveying control system includes a tracking system for tracking the location of said carriers.

28. A conveying system according to claim 1, wherein said retail data input system is adapted for inputting said conveying information including a delivery time.

29. A conveying system according to claim 19, wherein said customer unique identifier is derived from an object carried by said customer or a biometric of said customer.

30. A conveying system according to claim 1, wherein said customer unique identifier is derived from an object carried by said customer or a biometric of said customer, said conveying system includes at least one customer terminal connected to said conveying control system and adapted to allow a said customer to enter their unique identifier and access said conveying information for goods purchased by said customer.

31. A conveying system according to claim 30, wherein said retail data input system is adapted for inputting said conveying information including a delivery time, said at least one terminal is adapted to allow a said customer to change at least one of the conveying destination and the delivery time for said purchased goods.

32. A conveying system according to claim 1, including a purchase record system for recording a history of purchases made by said customers.

33. A conveying system according to claim 1, wherein said conveying control system includes a goods tracking system for tracking the location of conveyed goods.

34. A shopping complex comprising:
a plurality of independent retail outlets;
a conveying system according to any preceding claim; and
a central storage location storing goods for each said retail outlet;
wherein said loading arrangement is adapted to enable purchased goods to be loaded onto said conveying mechanism at said central location for conveying to said retail outlets or to a said collection point.

35. A method of conveying goods in a shopping complex comprising a plurality of independent retail outlets, the method comprising:
at a said retail outlet inputting conveying information related to purchased goods to a retail data input system to enable a customer to specify a conveying destination, said conveying information comprising an identification of purchased goods and said conveying destination for the purchased goods;
loading said purchased goods onto a conveyor mechanism; and
using a conveying control system connected to said retailer data input systems to control said conveyor mechanism in response to said conveying information to convey purchased goods to said conveying destination.

36. A method according to claim 35, wherein said loading comprises loading said purchased goods onto said conveyor mechanism at said retail outlet.

37. A method according to claim 35, wherein said shopping complex includes a central storage location storing goods for each said retail outlet, and said loading comprises loading said purchased goods onto said conveyor mechanism at said central storage location.

38. A method according to claim 35, wherein said shopping complex includes a central storage location storing goods for each said retail outlet, and said loading comprises loading said purchased goods onto said conveyor mechanism at said central storage location or loading said purchased goods onto said conveyor mechanism at said retail outlet.

39. A method according to claim 35, wherein said shopping complex includes a goods delivery location for receiving and/or storing goods to be delivered to said retail outlets, the method including loading goods to be delivered to said retail outlets onto said conveyor mechanism at said delivery location, inputting delivery conveying information related to goods to be delivered, said delivery conveying information comprising an identification of the goods to be delivered and a said retail outlet; and controlling said conveying control system to control said conveyor mechanism to convey said goods to be delivered from said delivery location to said retail outlets in accordance with said delivery conveying information.

40. A method according to claim 35, wherein said conveying control system records the delivery of goods and the purchase and conveyance of goods for stock control.

41. A method according to claim 35, wherein a customer can specify home delivery or a collection point as a said conveying destination, said shopping complex includes a home delivery transit location, and said conveying information identifies said conveying destination as said home delivery transit location or a said collection point.

42. A method according to claim 35, wherein said purchase goods are conveyed by said conveying mechanism to be at least in part visible to customers in public areas of said shopping complex to enable customers to view conveyed purchased goods.

43. A method according to claim 42, wherein said purchase goods are conveyed by said conveying mechanism adjacent to at least one customer viewing window.

44. A method according to claim 42, wherein video monitors generate a video display of the conveyance of the purchased goods for display in said public areas.

45. A method according to claim 42, wherein said purchase goods are conveyed by said conveying mechanism so as to pass through said public areas of said shopping complex.

46. A method according to claim 45, wherein said purchase goods are conveyed by said conveying mechanism in a transparent covering.

47. A method according to claim 45, wherein said purchase goods are conveyed by said conveying mechanism in transparent carriers.

48. A method according to claim 47, wherein said carriers include an identification mechanism for the unique identification of each said carrier, and said conveying information includes carrier identification data identifying said identification mechanism for a said carrier carrying purchased goods.

49. A method according to claim 47, wherein said carriers are sealed after said purchased goods are loaded into said carriers.

50. A method according to claim 47, wherein said carriers are removed from said conveying mechanism at said conveying destination.

51. A method according to claim 50, including carrying at least one said carrier on a trolley when removed from said conveying mechanism.

52. A method according to claim 48, wherein each said customer has a unique identifier, said conveying information includes a customer identifier, and said conveying control associates a said carrier to a customer using said conveying information if no said carrier is already associated with said customer and controls said conveyor mechanism to convey a said carrier already associated with said customer to a said retail outlet when said conveying information is input at a said retail data input system at said retail outlet which identifies said customer.

53. A method according to claim 48, including tracking the location of said carriers.

54. A method according to claim 35, wherein said carriers are sealed when said purchased goods are loaded into said carriers.

55. A method according to claim 35, wherein said conveying mechanism includes carriers carrying purchased goods.

56. A method according to claim 55, wherein said carriers include an identification mechanism for the unique identification of each said carrier, and said conveying information includes carrier identification data identifying said identification mechanism for a said carrier carrying purchased goods.

57. A method according to claim 55, wherein said carriers are removed from said conveying mechanism at said conveying destination.

58. A method according to claim 57, including carrying at least one said carrier in a trolley when removed from said conveying mechanism.

59. A method according to claim 56, wherein each said customer has a unique identifier, said conveying information includes a customer identifier, and said conveying control system associates a said carrier to a customer using said conveying information if no said carrier is already associated with said customer and controls said conveyor mechanism to convey a said carrier already associated with said customer to a said retail outlet when said conveying information is input at a said retail data input system at said retail outlet which identifies said customer.

60. A method according to claim 56, including tracking the location of said carriers.

61. A method according to claim 35, wherein said conveying information includes a delivery time.

62. A method according to claim 52, wherein said customer unique identifier is derived from an object carried by said customer or a biometric of said customer.

63. A method according to claim 35, wherein said customer unique identifier is derived from an object carried by said customer or a biometric of said customer, at one or more customer terminals connected to said conveying control system a said customer can enter their unique identifier and access said conveying information for goods purchased by said customer.

64. A conveying system according to claim 62, wherein said conveying information includes a delivery time, including receiving a request at a said terminal from a said customer to change at least one of the conveying destination and the delivery time for said purchased goods.

65. A method according to claim 35, including recording a history of purchases made by said customers.

66. A method according to claim 35, including tracking the location of conveyed goods.

67. A method of operating a shopping complex comprising a plurality of independent retail outlets, the method comprising:
operating a conveyor system capable of conveying goods purchased in any one of said retail outlets to a. plurality of designated locations in said shopping complex; and
in response to a purchase of goods at any one of said plurality of retail outlets and at the request of the customer, conveying purchased goods using said conveyor system to a said designated location in dependence upon the customer request.

68. A method according to claim 67, wherein said conveyor system is capable of conveying goods from any of said retail outlets to any of said designated locations, and said purchased goods are conveyed by said conveyor system from said retail outlet to said designated location.

69. A method according to claim 67, wherein goods are stored for said retail outlets in a central storage location remote from said retail outlets, said conveyor system is capable of conveying goods from said storage location to any one of said designated locations, and said purchased goods are conveyed by said conveyor system from said central storage location to said designated location.

70. A method according to claim 67, wherein goods can be stored for said retail outlets in a central storage location remote from said retail outlets, said conveyor system is capable of conveying goods from said storage location to any one of said designated locations and of conveying goods from any of said independent retail outlets to any one of said designated locations, and said retail outlet can elect to have said purchased goods conveyed by said conveyor system from said retail outlet to said designated location or from said central storage location to said designated location.

71. A method according to claim 67, wherein said designated locations comprise at least one of collection points in said shopping complex and a delivery dispatch location in said shopping complex; the request from said customer comprises one of convey said purchased goods to a said collection point and deliver said purchase goods to a location remote from said shopping complex; and in response to the request to deliver said purchased goods to said remote location, said purchased goods are conveyed using said conveyor system to said delivery dispatch location so that said purchased goods can be dispatched for delivery to said remote location.

72. A shopping complex comprising:
a plurality of retail outlets operated by unrelated entities; and
a conveyor system for conveying goods purchased from said retail outlets to a plurality of customer designatable locations in said shopping complex.

73. A shopping complex according to claim 72, wherein said conveyor system is at least in part visible to customers in public areas of said shopping complex to enable customers to view conveyed purchased goods.

74. A shopping complex according to claim 73, wherein said conveyor system extends into said public areas.

75. A shopping complex according to claim 73, wherein said conveying system is arranged in non public areas and said shopping complex includes at least one of:
windows for viewing at least a part of said conveying system, and
a video recording and displaying system to display an image of at least a part of said conveying system.

76. A shopping complex according to claim 72, including a central store for storing goods for said retail outlets, wherein said retail outlet can elect to have said purchased goods conveyed to said customer designatable locations from said retail outlet or said central store.

77. A shopping complex according to claim 72, including a central store for storing goods for said retail outlets, wherein said purchased goods are conveyed to said customer designatable locations from said central store.

78. A shopping complex according to claim 72, wherein said purchased goods are conveyed to said customer designatable locations from said retail outlet.

79. A shopping complex according to claim 72, including at least one customer terminal to enable a customer to designate or change the location to which said purchased goods are conveyed.

80. A shopping complex according to claim 79, wherein said at least one customer terminal is adapted to enable a customer to designate or change a time at which said purchased goods are ready for collection at said designated location.

81. A shopping complex according to claim 72, including a delivery dispatch location from which said purchased goods are dispatched for delivery to remote locations; wherein said customer designatable locations comprise at least one of: at least one collection point in said shopping complex and said delivery dispatch location in said shopping complex;

82. A method of operating a shopping complex comprising a plurality of retail outlets selling goods operated by unrelated entities, the method comprising:
requiring all entities operating said retail outlets to execute a rental agreement with an operator or owner of said shopping complex to the provision of services including a common goods conveyor system for conveying goods to and from said retail outlets, to and from at least one central storage location and to at least one customer collection location, and to make payments dependent upon recorded purchases;
operating said conveyor system to convey goods in accordance with said agreement;
recording purchases made for goods conveyed by said conveyor system; and
receiving said payments from said entities.

83. A method of operating a shopping complex comprising a plurality of retail outlets operated by independent entities; the method comprising:
assigning each customer with a unique identifier code based on an object provided to said customer or a biometric of said customer;
when a customer purchases goods from a said retail outlet, a record is made of the purchased goods, the customer identifier code, and a customer selected delivery location for said purchased goods from a selection of locations comprising a plurality of collection points in said shopping complex and a remote location, a plurality of said records being made with a common said selected location when said customer makes a plurality of purchases from a plurality of said retail outlets; and
delivering said goods purchased from a plurality of said retail outlets for said customer to said selected location.

84. A method according to claim 83, wherein said purchased goods are delivered to said selected location from either said retail outlet or a central common goods store for said retail outlets.

85. A method according to claim 84, wherein said retail outlet can determine to deliver said purchased goods from said central goods store for all purchases or only for selected purchases.

86. A method according to claim 83, wherein at least one customer terminal provides customer access to said records; and said at least one customer terminals receives a customer input to change said selected location.

87. A method according to claim 86, wherein said records include a time of delivery for said purchased goods, and said at least one customer terminal receives a customer input to change said time of delivery.

88. A method of operating a shopping complex comprising a plurality of retail outlets operated by independent entities, the method comprising, in response to a purchase of goods at any one of said plurality of retail outlets and at the request of the customer, placing said purchased goods in a carrier on a conveyor system, and conveying said purchased goods in said carrier to one of a plurality of designated locations in said shopping complex in dependence upon the customer request.

89. A method of advertising in a shopping complex, the method comprising affixing advertising material to carriers for holding purchased goods on a conveyor mechanism, and conveying the goods using the conveyor mechanism in public area of the shopping complex.

90. A conveying system according claim 26, wherein said conveying control system includes a tracking system for tracking the location of said carriers.
